(19) United States
(12) Patent Application Publication
(10) Pub. No.: US 2025/0117807 A1
(43) Pub. Date: Apr. 10, 2025

(54) Zero Knowledge Attestations for Carbon Footprint Metrics

(71) Applicant: Cisco Technology, Inc., San Jose, CA (US)

(72) Inventors: Marcelo Yannuzzi, Nuvilly (CH); Carlos Pignataro, Cary, NC (US)

(21) Appl. No.: 18/481,136

(22) Filed: Oct. 4, 2023

(51) Int. Cl. G06Q 30/018

(52) U.S. Cl. CPC G06Q 30/018; G06Q 2220/00

(57) ABSTRACT

Devices, systems, methods, and processes for generating and sharing a verifiable Zero Knowledge (ZK) proof are described herein. A device may utilize one or more non-reversible aggregation techniques to receive, normalize, and aggregate one or more Carbon Footprint Metrics (CFMs) of the device corresponding to a timeframe. The device can generate a ZK attestation and the verifiable ZK proof based on an aggregated CFM or a sum of normalized CFMs, and a carbon footprint threshold for the timeframe. The device may further transmit the verifiable ZK proof to an auditing device. The auditing device can receive the verifiable ZK proof and verify, in a trustworthy manner, that the CFMs of the device corresponding to the timeframe are in compliance with the carbon footprint threshold. The device may hence prove the compliance with the carbon footprint threshold to the auditing device without actually sharing the CFMs with the auditing device.

The present disclosure relates to communication networks. More particularly, the present disclosure relates to exporting Carbon Footprint Metrics (CFMs) of a device.

### BACKGROUND

Sustainability is a key objective of many governmental and corporate organizations. As public and private sectors transition to digital environments, a substantial portion of sustainability effort is focused on Information Technology (IT) systems. The IT systems include network domains, datacenters, or cloud servers etc. Assessing an environmental impact of the IT systems requires measuring, processing, and sharing various sustainability metrics. The sustainability metrics may include carbon footprint, energy consumption, water usage, or other such metrics that affect environment. To obtain certification or accreditation for an environmentally friendly IT system, it is necessary to share the sustainability metrics of the IT system within an organization or with external organizations.

Conventional IT systems focus primarily on measuring and accessing the sustainability metrics. The conventional IT systems are also limited to only a single network domain. That is, the conventional IT systems cannot selectively process the sustainability metrics and also cannot discretely share the sustainability metrics. Therefore, the conventional IT systems cannot function in multi-vendor or multi-domain infrastructures.

Some conventional IT systems that provide exchanging or sharing data focus only on sharing the data within the network domain or to external domains for traffic engineering purposes. That is, such conventional network domains do not relate to the sustainability metrics. Therefore, the conventional IT systems do not allow verification the sustainability metrics by the external domains, such as auditors, regulators, or the governmental or corporate organizations.

### SUMMARY OF THE DISCLOSURE

Systems and methods for exporting Carbon Footprint Metrics (CFMs) of a device in accordance with embodiments of the disclosure are described herein. In some embodiments, a device includes a processor, a memory communicatively coupled to the processor, and a sustainability logic. The logic is configured to receive one or more normalized Carbon Footprint Metrics (CFMs) corresponding to a timeframe, generate a Zero Knowledge (ZK) attestation if a sum of the one or more normalized CFMs is less than a carbon footprint threshold, generate a verifiable ZK proof based on the ZK attestation, and transmit the verifiable ZK proof to an auditing device.

In some embodiments, the verifiable ZK proof includes the ZK attestation, a device identifier corresponding to the device, and a time data.

In some embodiments, the time data includes at least one of the timeframe, or a timestamp indicative of a time of generation of the verifiable ZK proof.

In some embodiments, the sustainability logic is further configured to determine a key value and an offset value based on the one or more normalized CFMs and the carbon footprint threshold such that the sum of the one or more normalized CFMs and the offset value is greater than the carbon footprint threshold, and apply a hash on the key value based on at least one of the carbon footprint threshold, the offset value, or the sum of the one or more normalized CFMs to generate the ZK attestation.

In some embodiments, the verifiable ZK proof is verified by the auditing device by applying the hash on the verifiable ZK proof based on the carbon footprint threshold.

In some embodiments, the sustainability logic is further configured to compare the sum of the one or more normalized CFMs with the carbon footprint threshold dynamically, generate the verifiable ZK proof if the sum of the one or more normalized CFMs is less than the carbon footprint threshold, and adjust an energy consumption of the device dynamically if the sum of the one or more normalized CFMs is not less than the carbon footprint threshold.

In some embodiments, the one or more normalized CFMs correspond to at least one of a single greenhouse gas metric, multiple greenhouse gas metrics, or a composite sustainability metric.

In some embodiments, the sustainability logic is further configured to collect a real-time telemetry data indicative of a diverse sustainability data, and generate the one or more normalized CFMs based on the real-time telemetry data.

In some embodiments, the sustainability logic is further configured to determine an actual energy usage of the device based on the one or more normalized CFMs, and control an energy consumption of the device dynamically such that the actual energy usage of the device is less than a maximum energy usage indicated by the carbon footprint threshold.

In some embodiments, a method, includes receiving one or more normalized Carbon Footprint Metrics (CFMs) corresponding to a timeframe, generating a Zero Knowledge (ZK) attestation if a sum of the one or more normalized CFMs is less than a carbon footprint threshold, generating a verifiable ZK proof based on the ZK attestation, and transmitting the verifiable ZK proof to an auditing device.

In some embodiments, a method further includes determining a key value and an offset value based on the one or more normalized CFMs and the carbon footprint threshold such that the sum of the one or more normalized CFMs and the offset value is greater than the carbon footprint threshold, and applying a hash on the key value based on at least one of the carbon footprint threshold, the offset value, or the sum of the one or more normalized CFMs for generating the ZK attestation.

In some embodiments, a method further includes comparing the sum of the one or more normalized CFMs with the carbon footprint threshold dynamically, generating the verifiable ZK proof if the sum of the one or more normalized CFMs is less than the carbon footprint threshold, and adjusting an energy consumption of a device dynamically if the sum of the one or more normalized CFMs is not less than the carbon footprint threshold.

In some embodiments, a method further includes verifying the verifiable ZK proof by applying the hash on the verifiable ZK proof based on the carbon footprint threshold.

In some embodiments, a method further includes collecting a real-time telemetry data indicative of a diverse sustainability data, and generating the one or more normalized CFMs based on the real-time telemetry data.

In some embodiments, a device, includes a processor, a memory communicatively coupled to the processor, and a sustainability logic. The logic is configured to receive one or more normalized Carbon Footprint Metrics (CFMs) corresponding to a timeframe, compare a sum of the one or more normalized CFMs with a carbon footprint threshold dynamically, adjust an energy consumption of the device dynamically if the sum of the one or more normalized CFMs is not less than the carbon footprint threshold, and generate a Zero Knowledge (ZK) attestation if the sum of the one or more normalized CFMs is less than the carbon footprint threshold.

In some embodiments, the sustainability logic is further configured to generate a verifiable ZK proof that includes the ZK attestation, a device identifier corresponding to the device, and a time data, and transmit the verifiable ZK proof based on the ZK attestation to an auditing device.

In some embodiments, the time data includes at least one of the timeframe, or a timestamp indicative of a time of generation of the verifiable ZK proof.

In some embodiments, the sustainability logic is further configured to determine a key value and an offset value based on the one or more normalized CFMs and the carbon footprint threshold such that the sum of the one or more normalized CFMs and the offset value is greater than the carbon footprint threshold, and apply a hash on the key value based on at least one of the carbon footprint threshold, the offset value, or the sum of the one or more normalized CFMs to generate the ZK attestation.

In some embodiments, the verifiable ZK proof is verified by applying the hash on the verifiable ZK proof based on the carbon footprint threshold.

In some embodiments, the sustainability logic is further configured to collect a real-time telemetry data indicative of a diverse sustainability data, and generate the one or more normalized CFMs based on the real-time telemetry data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a system including a Sustainability Aggregation Entity (SAE) within a network domain in accordance with various embodiments of the disclosure;

FIG. 2 is a more detailed schematic block diagram of a system including a Sustainability Aggregation Entity (SAE) within a network domain in accordance with various embodiments of the disclosure;

FIG. 3 is a conceptual network diagram of various environments that a Sustainable Aggregation Entity (SAE) may operate on a plurality of network devices, in accordance with various embodiments of the disclosure;

FIG. 4 is a conceptual illustration of a process for verifying Carbon Footprint Metrics (CFMs), in accordance with various embodiments of the disclosure;

FIG. 5 is a conceptual illustration of a process for verifying Carbon Footprint Metrics (CFMs), in accordance with various embodiments of the disclosure;

FIG. 6 is a flowchart depicting a process for generating a verifiable Zero Knowledge (ZK) proof, in accordance with various embodiments of the disclosure;

FIG. 7 is a flowchart depicting a process for requesting a Zero Knowledge (ZK) attestation or adjusting an energy consumption, in accordance with various embodiments of the disclosure;

FIG. 8 is a flowchart depicting a process for transmitting a verifiable Zero Knowledge (ZK) proof, in accordance with various embodiments of the disclosure;

FIG. 9 is a flowchart depicting a process for verifying a verifiable Zero Knowledge (ZK) proof, in accordance with various embodiments of the disclosure;

FIG. 10 is a flowchart depicting a process for dynamically controlling an energy consumption, in accordance with various embodiments of the disclosure; and

FIG. 11 is a conceptual block diagram of a device suitable for configuration with a sustainability logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that generate and transmit a verifiable Zero Knowledge (ZK) proof. In many embodiments, a device can receive one or more Carbon Footprint Metrics (CFMs) from one or more Energy Providers (EPs). The EPs may include a variety of diverse energy sources, such as, but not limited to, solar power, wind power, hydro power, biomass power, nuclear power, or geothermal power. The EPs can also include variety of energy storage systems, such as, but not limited to, batteries, microgrids, Combined Heat and Power (CHP) systems, or fuel cells. An EP may record the CFMs of the device that receives power from the EP. The EP may provide the CFMs to the device when requested by the device. In some embodiments, the EP may provide attested CFMs to the device. The CFMs may include a single greenhouse gas (GHG) metric, multiple GHG metrics, or composite sustainability metrics. In certain embodiments, the device may include a non-reversible aggregation module that may receive multiple CFMs and combine the CFMs using one or more non-reversible aggregation techniques. In more embodiments, the non-reversible aggregation techniques may include hashing, tokenization, data masking, aggregating with noise, rounding, and binning, dimensionality reduction, random sampling, or other such techniques. The non-reversible aggregation module can generate an aggregated CFM of the device over a predetermined timeframe. The non-reversible aggregation module may further generate normalized CFMs for the timeframe. In more embodiments, the device can receive multiple CFMs from multiple EPs and normalize the CFMs over the timeframe to generate the normalized CFMs. The timeframe may be common to all EPs or may differ for every EP.

In a number of embodiments, the device can determine a sum of the normalized CFMs over the timeframe. The device may compare the sum of the normalized CFMs or the aggregated CFM with a carbon footprint threshold. If the sum of the normalized CFMs is less than the carbon footprint threshold, the device can determine a key value and an offset value based on the sum of the normalized CFMs or the aggregated CFM. The device may select the offset value such that the sum of the normalized CFMs and the offset value or the sum of the aggregated CFM and the offset value is greater than the carbon footprint threshold. The device can apply a hash on the key value based on at least one of: the carbon footprint threshold, the offset value, or the sum of the one or more normalized CFMs to generate a ZK attestation. For applying the hash, the device may select one or more hash functions based on a required security level or a required efficiency. In some embodiments, the hash functions may include cryptographic hash functions, non-cryptographic hash functions, checksum hash functions or other custom hash functions. The ZK attestation may prove the validity of the CFMs without actually sharing the CFMs. The device may also generate a verifiable ZK proof based on the ZK attestation. In certain embodiments, the verifiable ZK proof may include interactive ZK proofs, non-interactive ZK proofs, ZK Proofs of Knowledge (PoK), ZK Arguments of Knowledge (AoK), multi-party computation ZK proofs, adaptive ZK proofs, or other such ZK proofs. The verifiable ZK proof can include the ZK attestation, a device identifier corresponding to the device, and a time data. The verifiable ZK proof may be utilized to prove that the device complies to the carbon footprint threshold without disclosing any specifics about the sustainability data of the device. The time data may include at least one of: the timeframe, or a timestamp indicative of a time of generation of the verifiable ZK proof.

In various embodiments, the device may transmit the verifiable ZK proof to an auditing device. In some embodiments, the auditing device can apply the hash on the verifiable ZK proof based on the carbon footprint threshold to generate a response. The auditing device may compare the response with the verifiable ZK proof received from the device. The auditing device can verify the verifiable ZK proof when the response generated by the auditing device matches the verifiable ZK proof received from the device. In certain embodiments, the auditing device may correspond to an auditor, such as, but not limited to, a regulator, an organization, a different device, a different network domain, or an auditing agency.

In additional embodiments, the device can dynamically adjust an energy consumption of the device. In some embodiments, if the sum of the normalized CFMs is not less than the carbon footprint threshold, the device can adjust the energy consumption of the device dynamically. In some embodiments, to adjust the energy consumption, the device may change an operating power, an operating power mode, or an output signal strength. The device can also switch the energy consumption from a traditional energy source to a green energy source. In certain embodiments, the device may use historical data and/or real-time inputs to optimize the energy consumption of the device. The device can also schedule a new date or time to recompute the CFMs. In more embodiments, the device may collect a real-time telemetry data indicative of diverse sustainability data. In some more embodiments, the device can utilize near real-time telemetry data indicative of the sustainability data. The device can generate the CFMs based on the real-time telemetry data. The device can also normalize the generated CFMs based on the timeframe to generate the normalized CFMs. In numerous embodiments, the device can determine an actual energy usage of the device in the timeframe based on the normalized CFMs. The device may also determine a maximum energy usage based on the carbon footprint threshold. The device can further compare the actual energy usage with the maximum energy usage. If the actual energy usage is not less than the maximum energy usage, the device can control the energy consumption of the device dynamically. In many further embodiments, the device can adjust the energy consumption until the next date/time of recomputing the CFMs or until the actual energy usage complies with the carbon footprint threshold.

In further embodiments, if the actual energy usage is less than the maximum energy usage, the device can either generate the ZK attestation or transmit a request to a Certification Authority (CA). In some embodiments, the CA may receive the request from the device. The request can include the normalized CFMs, the time data, and the device identifier. The CA may generate the ZK attestation based on the request and transmit the ZK attestation to the device. The device can receive the ZK attestation from the CA and generate the verifiable ZK proof based on the received ZK attestation. In certain embodiments, the CA and the device may be included in a same network domain. In more embodiments, the CA and the device may be in different network domains.

Advantageously, the device can prove to the auditing device that the one or more CFMs of the device are compliant with the carbon footprint threshold over the timeframe without actually disclosing the CFMs to the auditing device, thereby preserving sensitivity or confidentiality of the sustainability data or the sustainability metrics of the device. By transmitting the verifiable ZK proof for the verification of the sustainability metrics, the device can have a control over an access to the sustainability metrics. The device can also automatically adjust the energy consumption to comply with the carbon footprint threshold in the timeframe without requiring any manual intervention. The device may also allow for temporal adaptation, in that the device may prove validity of the CFMs to the auditing device over the timeframe, any user-defined timeframe, or at a given point. The auto-adjustment of the energy consumption by the device can facilitate development of an intelligent system or an intelligent network of devices that can that self-regulate the energy consumption to comply with the carbon footprint threshold in the timeframe. Further, the auditing device may verify the verifiable ZK proof of the device in a trustworthy manner to determine that the sustainability data of the device complies with the carbon footprint threshold. The trustworthy verification by the auditing device can prevent greenwashing misconducts and thereby enhance reliability and transparency of the intelligent system or the intelligent network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

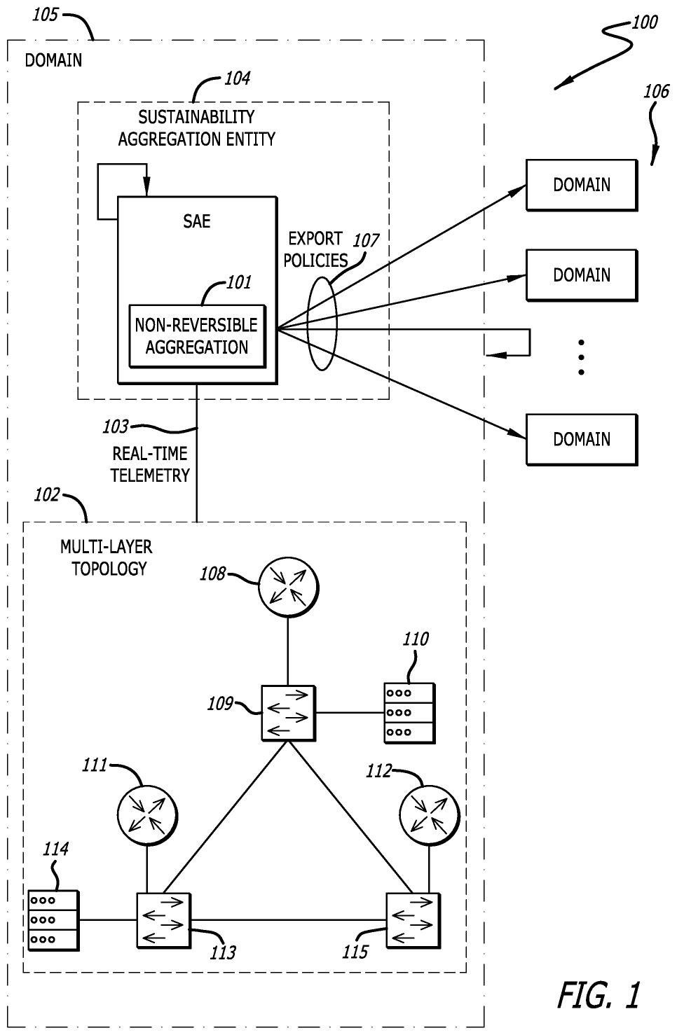

Referring to FIG. 1, a schematic block diagram of a system 100 including a Sustainability Aggregation Entity (SAE) 104 within a network domain 105, in accordance with various embodiments of the disclosure is shown. In many embodiments, the network domain 105 may include a plurality of switches, routers, compute nodes, storage, and other such elements, each of which consumes energy. The network domain 105 may also include a multi-layer topology 102, where information about the energy consumed by the different elements might be collected as a real-time telemetry data 103 or a near real-time telemetry data 103. In some embodiments, the multi-layer topology 102 may include a plurality of routers (108, 111, and 112), a plurality of switches (109, 113 and 115) and a plurality of storage elements (110 and 114). The real-time telemetry data 103 can be sent to the SAE 104. In certain embodiments, the real-time telemetry data 103 can include a diverse sustainability data. The diverse sustainability data may include information associated with an energy consumed by elements or components that are related to one or more network devices, or that support the SAE 104, and/or any observability elements, which can allow for the quantification of one or more sustainability-related attributes and/or metrics. Further, the SAE 104 includes a non-reversible aggregation module 101.

In a number of embodiments, the multi-layer topology 102 and the SAE 204 may be a part of a single domain 105 that is in communication with one or more external domains 206. The domain 105 can exchange data with the external domains 206 using one or more export policies (conceptually represented as the export policies 107 in FIG. 1). By utilizing these techniques, the system 100 can enable the SAE 104 to control an access to the diverse sustainability data or selective sharing of the diverse sustainability data with the external domains 106.

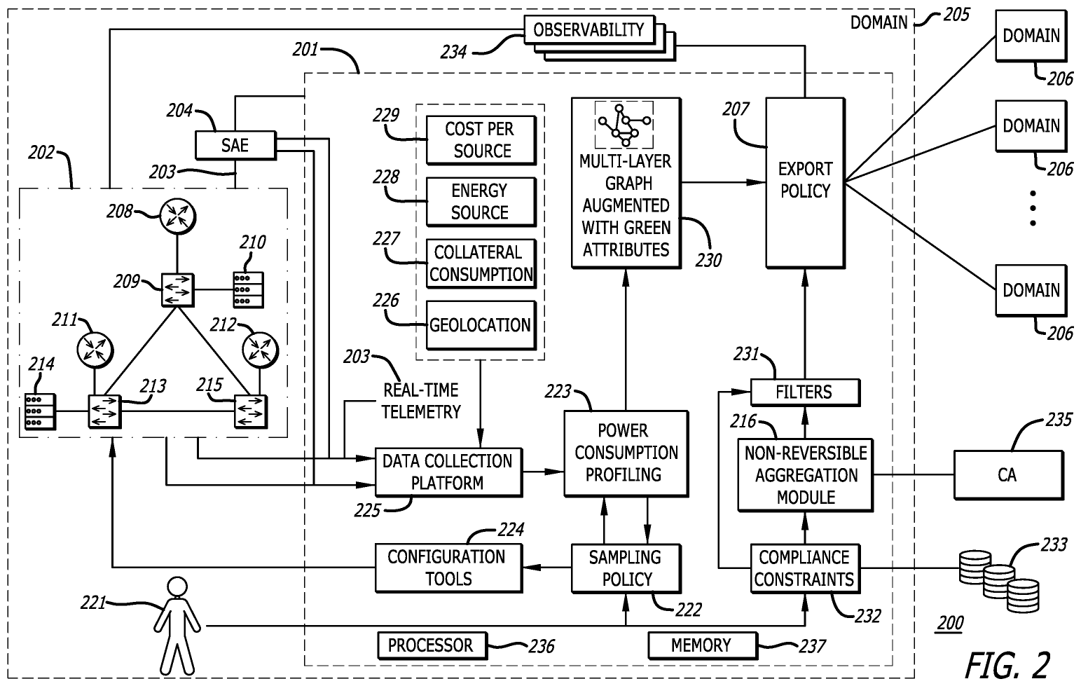

Although a specific embodiment for the system 100 is described above with respect to FIG. 1, any of a variety of systems and/or processes may be utilized in accordance with embodiments of the disclosure. For example, the SAE 104 may be a unique device or can be installed as part of a different network device as either hardware logic, software, or the like. The elements depicted in FIG. 1 may also be interchangeable with other elements of FIGS. 2-11 as required to realize a particularly desired embodiment.

Referring to FIG. 2, a more detailed schematic block diagram of a system 200 including a SAE 201 within a network domain 205, in accordance with various embodiments of the disclosure is shown. The system also includes a SAE 204 external to the domain 205. Specifically, the embodiment depicted in FIG. 2 can be considered as a more detailed version of the embodiment depicted in FIG. 1, wherein more detail is shown on the various components of the SAE 104 of FIG. 1. As such, a multi-layer topology 202 is still communicatively coupled to the SAE 204 and the SAE 201. In some embodiments, the multi-layer topology 202 may include a plurality of routers (208, 211, and 212), a plurality of switches (209, 213 and 215) and a plurality of storage elements (210 and 214). The domain 205 may communicate with one or more external domains 206 and a Certification Authority (CA) 235.

In many embodiments, such as the one depicted in FIG. 2, the SAE 201 may further comprise a controller/processor 236, a memory 237, and the diverse sustainability data such as a group comprising geolocation data 226, collateral consumption data 227, energy source data 228, and cost per source data 229. In some embodiments, various tools and platforms may be configured to manage data such as, but not limited to, a data collection platform 225, a sampling policy logic 222, a power consumption profiling logic 223, and one or more configuration tools 224. In certain embodiments, various data sources can be utilized by one or more tools or platforms to generate a multi-layer topology graph 230. Specifically, in more embodiments, the multi-layer topology graph 230 is generated and augmented with one or more “green” or sustainability-related attributes.

In a number of embodiments, the multi-layer topology graph 230 can be pruned with one or more sources of data such as data provided through an export policy 207 which can include, but is not limited to, filters 231, a non-reversible aggregation module 216, or compliance constraints 232. In some embodiments, the compliance constraints 232 can be modified or otherwise guided by one or more data governance rules and regulations 233. Additionally, the export policy 207 can be modified through an observability logic (not shown) which can direct one or more observability elements 234. Finally, an administrator 221 can adjust or otherwise affect one or more components or data sources within the system 200 based on a desired application.

Although a specific embodiment for the system 200 is described above with respect to FIG. 2, any of a variety of systems and/or processes may be utilized in accordance with embodiments of the disclosure. For example, the SAE 204 may control and process the diverse sustainability data and may provide selective access to the diverse sustainability data. The elements depicted in FIG. 2 may also be interchangeable with other elements of FIGS. 1 and 3-11 as required to realize a particularly desired embodiment.

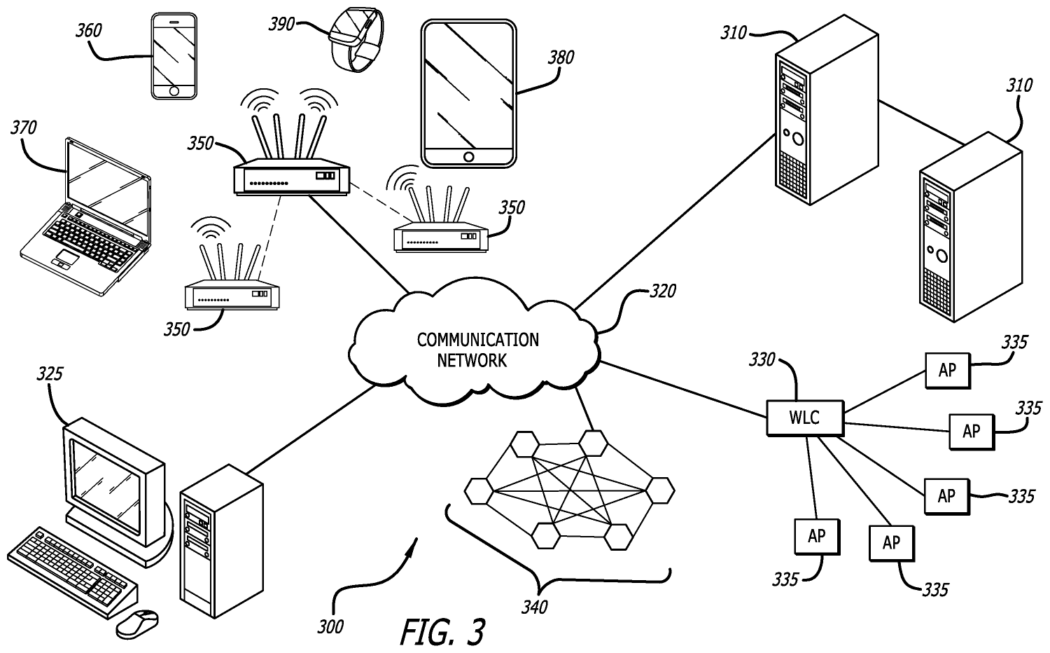

Referring to FIG. 3, a conceptual network diagram 300 of various environments that the SAE may operate on a plurality of network devices, in accordance with various embodiments of the disclosure is shown. Those skilled in the art will recognize that the SAE can include various hardware and/or software deployments and can be configured in a variety of ways. In many embodiments, the SAE can be configured as a standalone device, exist as a logic in another network device, be distributed among various network devices operating in tandem, or remotely operated as part of a cloud-based network management tool. In further embodiments, one or more servers 310 can be configured with the SAE or can otherwise operate as the SAE. In many embodiments, the SAE may operate on one or more servers 310 connected to a communication network 320. The communication network 320 can include wired networks or wireless networks. The SAE can be provided as a cloud-based service that can service remote networks, such as, but not limited to a deployed network 340. In many embodiments, the SAE can be a logic that can process the diverse sustainability data of the devices in a network domain.

However, in additional embodiments, the SAE may be operated as a distributed logic across multiple network devices. In the embodiment depicted in FIG. 3, a plurality of network access points (APs) 350 can operate as the SAE in a distributed manner or may have one specific device operate as the SAE for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the SAE may be integrated within another network device. In the embodiment depicted in FIG. 3, a wireless LAN controller (WLC) 330 may have an integrated SAE that the WLC 330 can use to process the diverse sustainability data of the APs 335 that the WLC 330 is connected to, either wired or wirelessly. In still more embodiments, a personal computer 325 may be utilized to access and/or manage various aspects of the SAE, either remotely or within the network itself. In the embodiment depicted in FIG. 3, the personal computer 325 communicates over the communication network 320 and can access the SAE of the servers 310, or the network APs 350, or the WLC 330.

Although a specific embodiment for various environments that the SAE may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the SAE may be provided as a device or software separate from the WLC 330 or the SAE may be integrated into the WLC 330. The elements depicted in FIG. 3 may also be interchangeable with other elements of FIGS. 1-2 and 4-11 as required to realize a particularly desired embodiment.

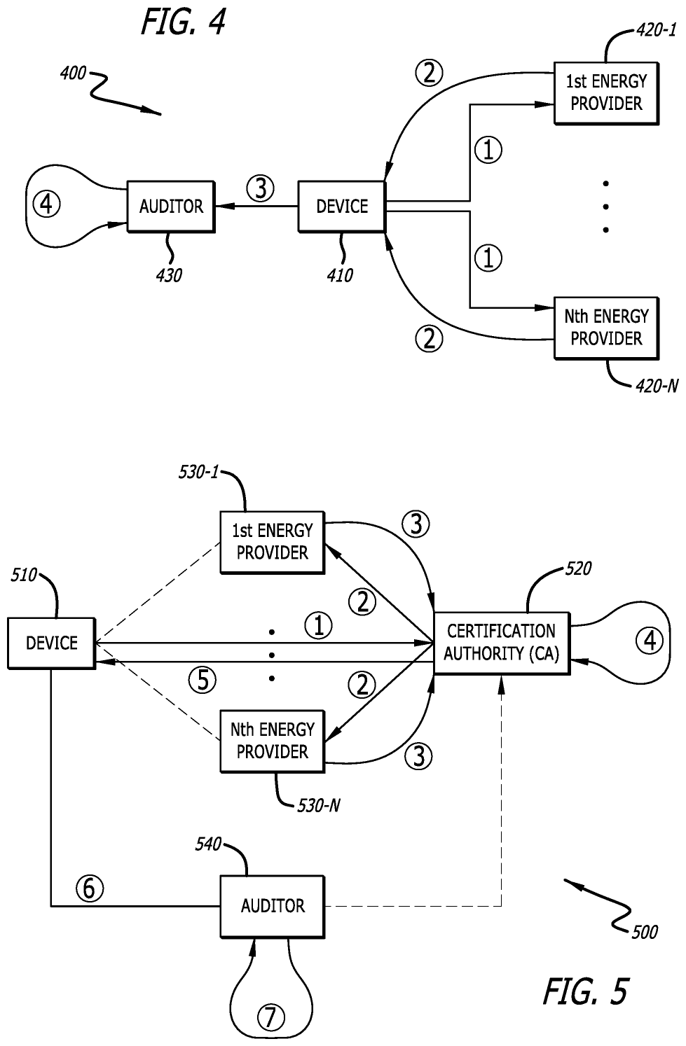

Referring now to FIG. 4, a conceptual illustration of a process 400 of verifying Carbon Footprint Metrics (CFMs), in accordance with various embodiments of the disclosure is shown. In many embodiments, a device 410 can transmit a plurality of requests to a plurality of Energy Providers (EPs) (420-1 to 420-N) (step 1). In some embodiments, the request may include a device identifier and a timeframe. In certain embodiments, the timeframe may be a predetermined period of time. In some more embodiments, the EPs (420-1 to 420-N) may include variety of diverse energy sources, such as, but not limited to, solar power, wind power, hydro power, biomass power, nuclear power, or geothermal power. In numerous embodiments, the EPs (420-1 to 420-N) can also include variety of energy storage systems, such as, but not limited to, batteries, microgrids, Combined Heat and Power (CHP) systems, or fuel cells.

In a number of embodiments, the EPs (420-1 to 420-N) may transmit one or more Carbon Footprint Metrics (CFMs) to the device (step 2). In some embodiments, the CFMs may correspond to the device 410. In certain embodiments, the CFMs may include a single greenhouse gas (GHG) metric, multiple GHG metrics, or a composite sustainability metric. In more embodiments, the EPs (420-1 to 420-N) may transmit one or more normalized CFMs to the device 410. In some more embodiments, the EPs (420-1 to 420-N) may provide attested CFMs to the device 410. In numerous embodiments, the timeframe may be common to all EPs (420-1 to 420-N) or may differ for every EP.

In various embodiments, the device 410 can receive and process the CFMs (step 3). In some embodiments, the device 410 may include a non-reversible aggregation module that may normalize and/or combine the CFMs using a non-reversible aggregation technique to generate an aggregated CFM. In certain embodiments, the non-reversible aggregation module can generate the aggregated CFM corresponding to the timeframe. In more embodiments, the non-reversible aggregation techniques may include hashing, tokenization, data masking, aggregating with noise, rounding, and binning, dimensionality reduction, random sampling, or other such techniques. In some more embodiments, the device 410 may further generate a Zero Knowledge (ZK) attestation based on the normalized CFMs and a carbon footprint threshold. In numerous embodiments, the device 410 can also generate a verifiable ZK proof based on the ZK attestation. In many further embodiments, the verifiable ZK proof may include interactive ZK proofs, non-interactive ZK proofs, ZK Proofs of Knowledge (PoK), ZK Arguments of Knowledge (AoK), multi-party computation ZK proofs, adaptive ZK proofs, or other such ZK proofs.

In additional embodiments, the device 410 may transmit the verifiable ZK proof to an auditor 430. In some embodiments, the verifiable ZK proof can include the ZK attestation, a device identifier corresponding to the device 410, and a time data. In certain embodiments, the time data may include at least one of: the timeframe, or a timestamp indicative of a time of generation of the verifiable ZK proof by the device 410. In more embodiments, the auditor 430 can verify the verifiable ZK proof based on the carbon footprint threshold (step 4).

Although a specific embodiment for verifying the CFMs for carrying out the various steps, processes, methods, and operations described herein is discussed with respect to FIG. 4, any of a variety of systems and/or processes may be utilized in accordance with embodiments of the disclosure. In many non-limiting examples, the auditor 450 can verify the CFMs of the device 410 without actually receiving the CFMs from the device 420. The elements depicted in FIG. 4 may also be interchangeable with other elements of FIGS. 1-3 and 5-11 as required to realize a particularly desired embodiment.

Referring now to FIG. 5, a conceptual illustration of a process 500 of verifying the CFMs, in accordance with various embodiments of the disclosure is shown. In many embodiments, a device 510 may transmit a request to a Certification Authority (CA) 520 (step 1). In some embodiments, the request may include a device identifier of the device 510 and a timeframe. In certain embodiments, the timeframe may correspond to a period of time corresponding to which the device 510 requests the CA 520 to generate the ZK attestation.

In a number of embodiments, the CA can request a plurality of EPs (530-1 to 530-N) (step 2). In some embodiments, the request transmitted by the CA 520 to the EPs (530-1 to 530-N) may also include the device identifier of the device 510 and the timeframe. In certain embodiments, the EPs (530-1 to 530-N) can be one or more energy providers to the device 510. In more embodiments, the EPs (530-1 to 530-N) may measure and store the CFMs corresponding to an energy consumption of the device 510.

In various embodiments, the EPs (530-1 to 530-N) may transmit the CFMs of the device 510 to the CA 520 (step 3). In some embodiments, the EPs (530-1 to 530-N) may determine the CFMs of the device 510 corresponding to the timeframe and selectively transmit the CFMs corresponding to the timeframe. In certain embodiments, the CFMs can indicate one or more sustainability metrics corresponding to the energy consumed by the device 510 in the period of time indicated by the timeframe. In more embodiments, the EPs (530-1 to 530-N) may attest the CFMs of the device 510 corresponding to the timeframe. In some more embodiments, the EPs (530-1 to 530-N) may transmit the attested CFMs to the CA 520.

In additional embodiments, the CA 520 can generate the ZK attestation (step 4). In some embodiments, the CA 520 may normalize the CFMs. In certain embodiments, the CA 520 may determine the sum of the normalized CFMs. In more embodiments, the CA 520 can compare the sum of the normalized CFMs with the carbon footprint threshold. In some more embodiments, the CA 520 may also generate the ZK attestation based on the normalized CFMs and the carbon footprint threshold.

In further embodiments, the CA 520 may transmit the ZK attestation to the device 510 (step 5). In some embodiments, the CA 520 may transmit the ZK attestation along with the attested CFMs. In certain embodiments, the CA 520 may generate a CFM attestation certificate including the ZK attestation, the attested CFMs, the device identifier, and the time data. In more embodiments, the CA 520 may transmit the CFM attestation certificate to the device 510. In some more embodiments, the CFM attestation certificate may indicate that the energy consumption of the device 510 complies with the carbon footprint threshold for the timeframe.

In many more embodiments, the device 510 can receive the ZK attestation or the CFM attestation certificate from the CA 520. In some embodiments, the device 510 generates the verifiable ZK proof based on the ZK attestation or the CFM attestation certificate. In certain embodiments, the verifiable ZK proof can include the ZK attestation, a device identifier corresponding to the device, and a time data. In more embodiments, the device 510 can transmit the verifiable ZK proof to the auditor 540 (step 6).

In many additional embodiments, the auditor 540 may verify the verifiable ZK proof (step 7). In some embodiments, the auditor 540 may successfully verify the verifiable ZK proof only when the attested CFMs of the device 510 comply with the carbon footprint threshold for the timeframe. In certain embodiments, the auditor 540 may not have access to the actual CFMs of the device 510 for the timeframe.

Although a specific embodiment for verifying the CFMs for carrying out the various steps, processes, methods, and operations described herein is discussed with respect to FIG. 5, any of a variety of systems and/or processes may be utilized in accordance with embodiments of the disclosure. In many non-limiting examples, the auditor 540 can successfully verify the CFMs of the device 510 only when the energy consumption of the device complies with the carbon footprint threshold. The elements depicted in FIG. 5 may also be interchangeable with other elements of FIGS. 1-4 and 6-11 as required to realize a particularly desired embodiment.

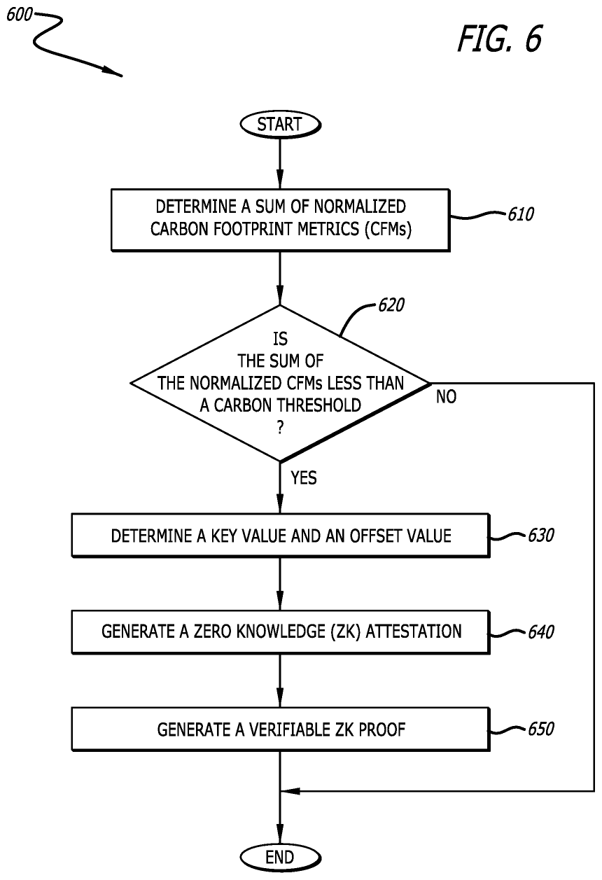

Referring now to FIG. 6, a flowchart depicting a process 600 for generating the verifiable ZK proof, in accordance with various embodiments of the disclosure is shown. In many embodiments, the process 600 can determine the sum of the normalized CFMs (block 610). In some embodiments, the process 600 may utilize non-reversible aggregation techniques to generate the sum of the normalized CFMs or the aggregated CFM.

In a number of embodiments, the process 600 may compare the sum of the normalized CFMs with the carbon footprint threshold (block 620). In some embodiments, the process 600 can compare the aggregated CFM with the carbon footprint threshold corresponding to the timeframe. In certain embodiments, the carbon footprint threshold may correspond to a maximum energy usage allowable in the timeframe. In more embodiments, if the sum of the normalized CFMs or the aggregated CFM is less than the carbon footprint threshold, the energy consumption of the device is less than the maximum energy usage in the timeframe. In some more embodiments, the process 600 does not generate the verifiable ZK proof if the sum of the normalized CFMs or the aggregated CFM is not less than the carbon footprint threshold for the timeframe.

In various embodiments, the process 600 can determine a key value and an offset value based on the normalized CFMs and the carbon footprint threshold (block 630). In some embodiments, the process 600 may select the offset value such that the sum of the normalized CFMs and the offset value is greater than the carbon footprint threshold. In certain embodiments, the process 600 can select a hash function, or simply, a hash, for generation of the ZK attestation. In more embodiments, the process 600 may select one or more hash functions based on a required security level or a required efficiency. In some more embodiments, the hash functions may include cryptographic hash functions, non-cryptographic hash functions, checksum hash functions or other custom hash functions.

In additional embodiments, the process 600 may generate the ZK attestation (block 640). In some embodiments, the process 600 can apply a hash on the key value based on at least one of: the carbon footprint threshold, the offset value, or the sum of the one or more normalized CFMs to generate a ZK attestation. In certain embodiments, the process 600 may further apply the hash on the key value repeatedly for a predetermined number of times.

In further embodiments, the process 600 may generate the verifiable ZK proof based on the ZK attestation (block 650). In some embodiments, the verifiable ZK proof can include the ZK attestation, the device identifier corresponding to the device, and the time data. In certain embodiments, the process 600 may transmit the verifiable ZK proof to an auditing device for verification.

Although a specific embodiment for generating the verifiable ZK proof for carrying out the various steps, processes, methods, and operations described herein is discussed with respect to FIG. 6, any of a variety of systems and/or processes may be utilized in accordance with embodiments of the disclosure. In many non-limiting examples, the generation of the verifiable ZK proof may be utilized to verify the energy consumption of the device in a trustworthy manner. The elements depicted in FIG. 6 may also be interchangeable with other elements of FIGS. 1-5 and 7-11 as required to realize a particularly desired embodiment.

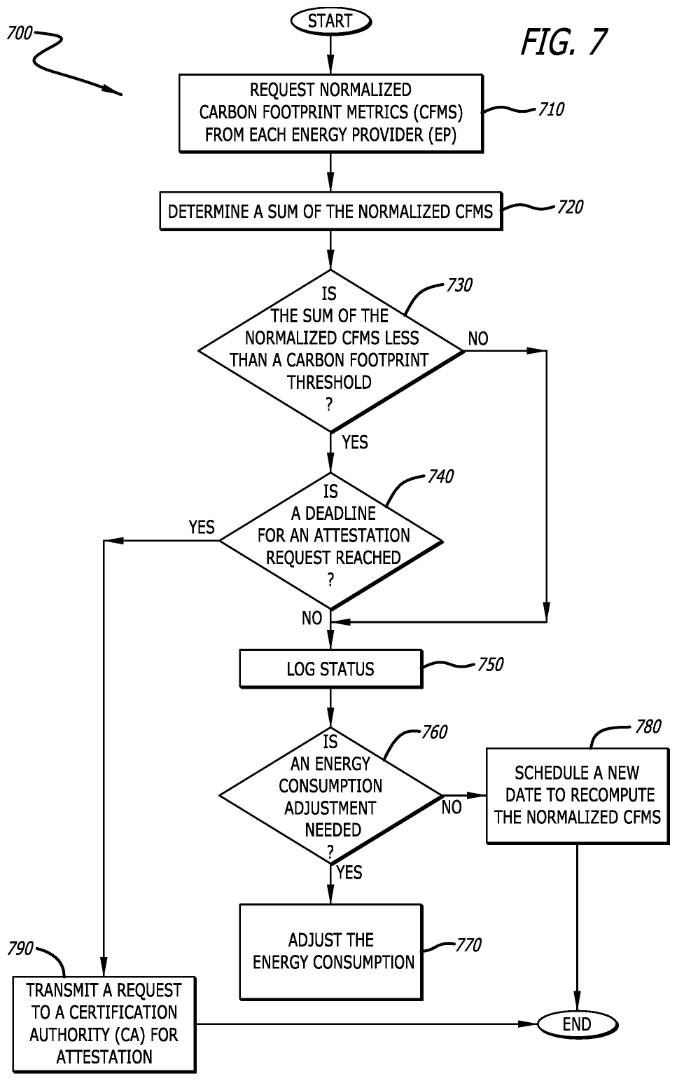

Referring now to FIG. 7, is a flowchart depicting a process 700 for requesting the ZK attestation or adjusting an energy consumption, in accordance with various embodiments of the disclosure is shown. In many embodiments, the process 700 may request the EPs for the normalized CFMs or the attested CFMs (block 710). In some embodiments, the process 700 may select the timeframe for which the CFMs are requested. In certain embodiments, the process 700 may be implemented by the device.

In a number of embodiments, the process 700 can determine the sum of the normalized CFMs or the sum of the attested CFMs to generate the aggregated CFM (block 720). In some embodiments, the device may utilize non-reversible aggregation techniques to generate the aggregated CFM. In certain embodiments, individual CFMs may not be recoverable based on the aggregated CFM.

In various embodiments, the process 700 may compare the aggregated CFM with the carbon footprint threshold (block 730). In some examples, the carbon footprint threshold may correspond to the timeframe, and may differ for different timeframes. In certain embodiments, the carbon footprint threshold can be indicative of the maximum energy consumption allowable in the timeframe.

In additional embodiments, if the aggregated CFM is less than the carbon footprint threshold, the process 700 can determine if a deadline for an attestation has reached (block 740). In some embodiments, the process 700 may be required to attest the normalized CFMs periodically. In certain embodiments, the process 700 may decide the deadline for the attestation based on a difference between the aggregated CFM and the carbon footprint threshold.

In further embodiments, if the sum of the normalized CFMs is not less than the carbon footprint threshold and/or the deadline for the attestation has not reached, the process 700 may log a status of the CFMs in the memory (block 750). In some embodiments, the process 700 may also store the aggregated CFM into a memory in the device. In certain embodiments, the process 700 can store an updated aggregated CFM or a difference with respect to a previous aggregated CFM in the memory.

In many more embodiments, the process 700 can determine if an adjustment in the energy consumption of the device is required (block 760). In some embodiments, the process 700 may decide whether the energy consumption of the device should be adjusted based on a comparison of the actual energy consumption of the device with the maximum energy consumption indicated by the carbon footprint threshold. In certain embodiments, the actual energy consumption and the maximum energy consumption may correspond to the timeframe, and may differ for different timeframes.

In many additional embodiments, if the process 700 decides that the adjustment in the energy consumption is necessary, the process 700 may also adjust the energy consumption of the device (block 770). In some embodiments, the energy consumption of the device can be adjusted by operating the device in a low power mode. In certain embodiments, the energy consumption of the device may be altered by switching to green or sustainable energy sources.

In many further embodiments, if the process 700 decides that the adjustment in the energy consumption is not necessary, the process 700 can schedule a new date to recompute the normalized CFMs (block 780). In some embodiments, the process 700 may schedule the new date as per a predefined schedule. In certain embodiments, the process 700 can schedule the new date based on the difference between the aggregated CFM and the carbon footprint threshold.

In many more embodiments, if the process 700 determines that the deadline for the attestation has reached, the process 700 may transmit the request to the CA for the attestation (block 790). In some embodiments, the process 700 can transmit the aggregated CFM, the device identifier, and the timeframe to the CA. In certain embodiments, the process 700 may receive the ZK attestation from the CA. In more embodiments, the process 700 can receive the CFM attestation certificate from the CA.

Although a specific embodiment for requesting the ZK attestation or adjusting an energy consumption for carrying out the various steps, processes, methods, and operations described herein is discussed with respect to FIG. 7, any of a variety of systems and/or processes may be utilized in accordance with embodiments of the disclosure. In many non-limiting examples, the CA may generate and provide the ZK attestation or the CFM attestation certificate to the device based on the carbon footprint threshold. The elements depicted in FIG. 7 may also be interchangeable with other elements of FIGS. 1-6 and 8-11 as required to realize a particularly desired embodiment.

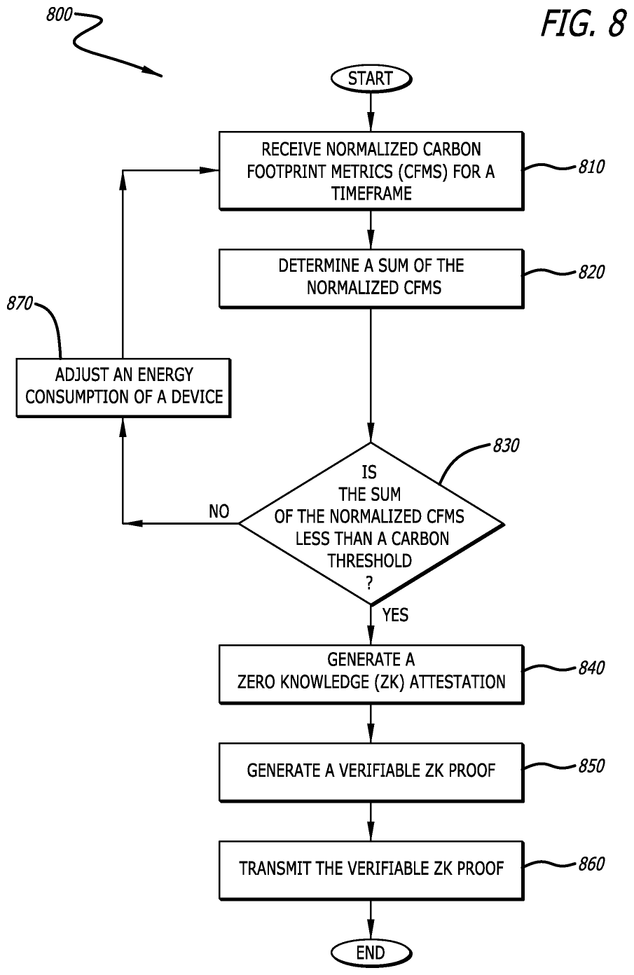

Referring now to FIG. 8, a flowchart depicting a process 800 for transmitting the verifiable ZK proof, in accordance with various embodiments of the disclosure is shown. In many embodiments, the process 800 may receive the normalized CFMs for the timeframe (block 810). In some embodiments, the process 800 can transmit a request to each EP for the attested CFMs. In certain embodiments, the process 800 may further receive the attested CFMs from the EPs. In more embodiments, the process 800 may further receive one or more attestation certificates corresponding to the attested CFMs from the EPs.

In a number of embodiments, the process 800 can determine the sum of the normalized CFMs (block 820). In some embodiments, the process 800 may aggregate the CFMs to generate the aggregated CFM. In certain embodiments, the process 800 may also utilize non-reversible aggregation techniques for generating the aggregated CFM. In more embodiments, the process 800 can receive multiple CFMs from multiple EPs and normalize the CFMs over the timeframe to generate the aggregated CFM. In some more embodiments, the timeframe may be common to all EPs or may differ for every EP.

In various embodiments, the process 800 can compare the aggregated CFM to the carbon footprint threshold (block 830). In some examples, the process 800 may perform the comparison in real-time or in near real-time. In certain embodiments, the process 800 can perform the comparison periodically after predetermined intervals.

In additional embodiments, if the process 800 determines that the aggregated CFM is less than the carbon footprint threshold, the process 800 may generate the ZK attestation (block 840). In some examples, the process 800 cannot generate the ZK attestation if a condition on the aggregated CFM is not met, thereby avoiding the greenwashing misconducts. In certain embodiments, the process 800 may recompute and/or monitor the CFMs until the condition on the aggregated CFM is met.

In further embodiments, the process 800 can generate the verifiable ZK proof (block 850). In some embodiments, the verifiable ZK proof is generated by utilizing one or more hash functions. In certain embodiments, the hash function may be selected based on one or more security requirements or efficiency requirements of the CA.

In many more embodiments, the process 800 may transmit the verifiable ZK proof to the auditor (block 860). In some embodiments, the auditor may apply the selected hash function on the verifiable ZK proof to verify that the condition on the aggregated CFM is met. In certain embodiments, the auditor can repeatedly apply the hash function based on the carbon footprint threshold.

In many additional embodiments, if the condition for the aggregated CFM is not met, the process 800 may adjust the energy consumption of the device (block 870). In some embodiments, the process 800 can dynamically control the power consumption of the device to achieve the condition on the aggregated CFM. In certain embodiments, the process 800 may adjust the energy consumption of the device by changing an operating power, an operating power mode, or an output signal strength of the device. In more embodiments, the process 800 can also switch the energy provider of the device from a traditional energy source to a green energy source. In some more embodiments, the process 800 may use historical data and/or real-time inputs to optimize the energy consumption of the device.

Although a specific embodiment for transmitting the verifiable ZK proof or adjusting the energy consumption of the device for carrying out the various steps, processes, methods, and operations described herein is discussed with respect to FIG. 8, any of a variety of systems and/or processes may be utilized in accordance with embodiments of the disclosure. In many non-limiting examples, the process 800 may self-regulate the energy consumption of the domain based on the carbon footprint threshold. The elements depicted in FIG. 7 may also be interchangeable with other elements of FIGS. 1-7 and 9-11 as required to realize a particularly desired embodiment.

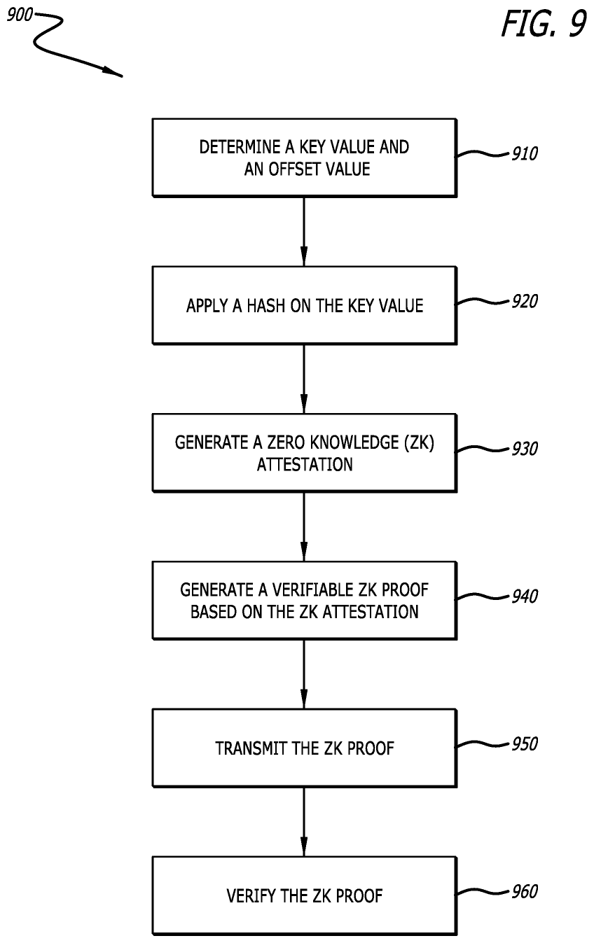

Referring now to FIG. 9, a flowchart depicting a process 900 for verifying the verifiable ZK proof, in accordance with various embodiments of the disclosure is shown. In many embodiments, the process 900 may determine the key value and the offset value (block 910). In some embodiments, the process 900 may select the offset value such that the sum of the normalized CFMs and the offset value is greater than the carbon footprint threshold.

In a number of embodiments, the process 900 can apply the hash on the key value (block 920). In some embodiments, the process 900 may choose the hash functions based on a required security standard. In certain embodiments, the technique of applying the hash on the key value may differ based on the hash function selected by the process 900. In more embodiments, the process 900 may apply the hash function to the key value repeatedly to transform the key value into a commitment which may be utilized by the auditor to verify the verifiable ZK proof. In some more embodiments, the ZK attestation may prove the validity of the CFMs without actually sharing the CFMs.

In various embodiments, the process 900 may generate the ZK attestation (block 930). In some embodiments, the process 900 generates the ZK attestation after repeatedly applying the hash function based on at least one of: the carbon footprint threshold, the offset value, or the aggregated CFM. In certain embodiments, the verifiable ZK proof may be utilized by the process 900 to prove that the device complies to the carbon footprint threshold without disclosing any specifics about the sustainability data of the device.

In additional embodiments, the process 900 can generate the verifiable ZK proof based on the ZK attestation (block 940). In some embodiments, the verifiable ZK proof indicates that the aggregated CFM complies to the carbon footprint threshold. In certain embodiments, the verifiable ZK proof may include the ZK attestation, the device identifier corresponding to the device, and the time data.

In further embodiments, the process 900 may transmit the verifiable ZK proof to the auditor (block 950). In some embodiments, the auditor may be a regulator, an organization, a different device, a different network domain, or an auditing agency. In certain embodiments, the auditor has no access to the actual CFMs as the device applies the non-reversible aggregation techniques over the CFMs to generate the verifiable ZK proof.

In many more embodiments, the process 900 can verify the verifiable ZK proof (block 960). In some embodiments, the auditor may apply the hash on the verifiable ZK proof based on the carbon footprint threshold to generate a response. In certain embodiments, the auditing device may compare the response with the verifiable ZK proof received from the device. In more embodiments, the auditing device can verify the verifiable ZK proof when the response generated by the auditing device matches the verifiable ZK proof received from the device.

Although a specific embodiment for transmitting the verifiable ZK proof for carrying out the various steps, processes, methods, and operations described herein is discussed with respect to FIG. 9, any of a variety of systems and/or processes may be utilized in accordance with embodiments of the disclosure. In many non-limiting examples, the process 900 may facilitate verification of the CFMs by the auditor without actually sharing the CFMs with the auditor. The elements depicted in FIG. 9 may also be interchangeable with other elements of FIGS. 1-8 and 10-11 as required to realize a particularly desired embodiment.

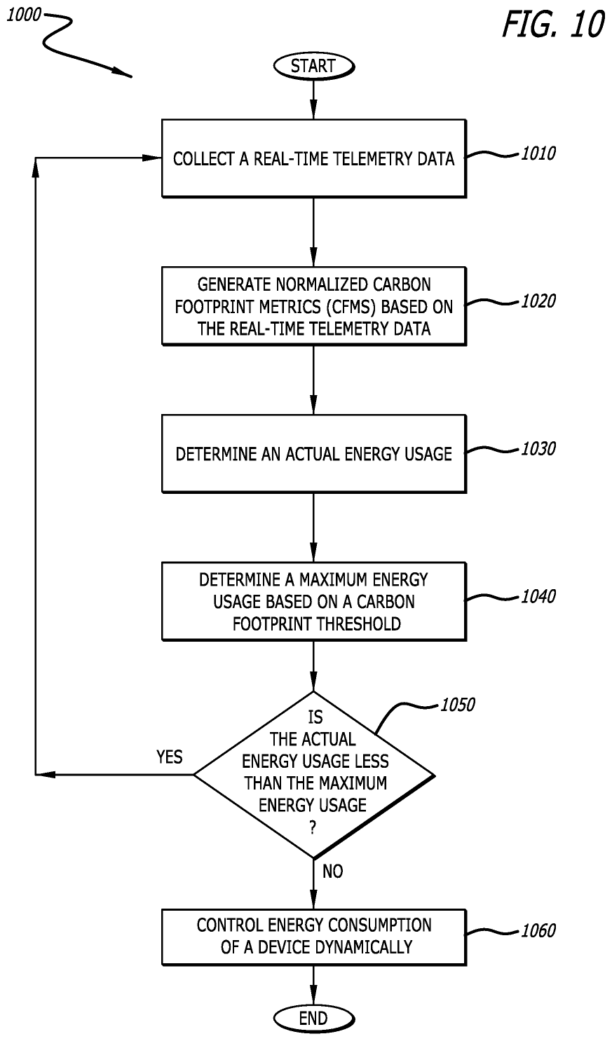

Referring now to FIG. 10, a flowchart depicting a process 1000 for dynamically controlling the energy consumption, in accordance with various embodiments of the disclosure is shown. In many embodiments, the process 1000 may collect the real-time telemetry data (block 1010). In some embodiments, the real-time telemetry data may be collected in near-real time. In certain embodiments, the real-time telemetry data can include the diverse sustainability data which may be sensitive in nature.

In a number of embodiments, the process 1000 can generate the normalized CFMs based on the real-time telemetry data (block 1020). In some embodiments, the real-time telemetry data may relate to information associated with the energy consumption by the device and/or the observability elements which can allow for the quantification of the CFMs. In certain embodiments, the process 1000 can normalize and aggregate the CFMs by the non-reversible techniques.

In various embodiments, the process 1000 may determine the actual energy usage (block 1030). In some embodiments, the actual energy usage may correspond to the power consumed by the device and/or the observability elements corresponding to the network domain. In certain embodiments, the actual energy usage corresponds to the power provided to the device by the EPs.

In additional embodiments, the process 1000 can determine the maximum energy usage based on the carbon footprint threshold (block 1040). In some embodiments, the maximum energy usage may be indicated by the carbon footprint threshold. In certain embodiments, the maximum energy usage may correspond to the timeframe. In more embodiments, the maximum energy usage may differ based on the timeframe, the type of device, the type of network domain, etc.

In further embodiments, the process 1000 compares the actual energy usage with the maximum energy usage (block 1050). In some embodiments, the process 1000 compares the aggregated CFM with the carbon footprint threshold. In certain embodiments, the process 1000 performs the comparison in real-time or in near real-time.

In many more embodiments, if the actual energy usage is not less than the maximum energy usage, the process 1000 dynamically controls the energy consumption of the device (block 1060). In some embodiments, the device self-regulates the energy consumption such that the actual energy consumption complies with the maximum energy usage for the timeframe. In certain embodiments, the process 1000 collects next telemetry data if the actual energy usage is less than the maximum energy usage.

Although a specific embodiment for dynamically controlling the energy consumption for carrying out the various steps, processes, methods, and operations described herein is discussed with respect to FIG. 10, any of a variety of systems and/or processes may be utilized in accordance with embodiments of the disclosure. In many non-limiting examples, the process 1000 may constantly monitor and control the energy consumption of the device to comply with the carbon footprint threshold. The elements depicted in FIG. 10 may also be interchangeable with other elements of FIGS. 1-9 and 11 as required to realize a particularly desired embodiment.

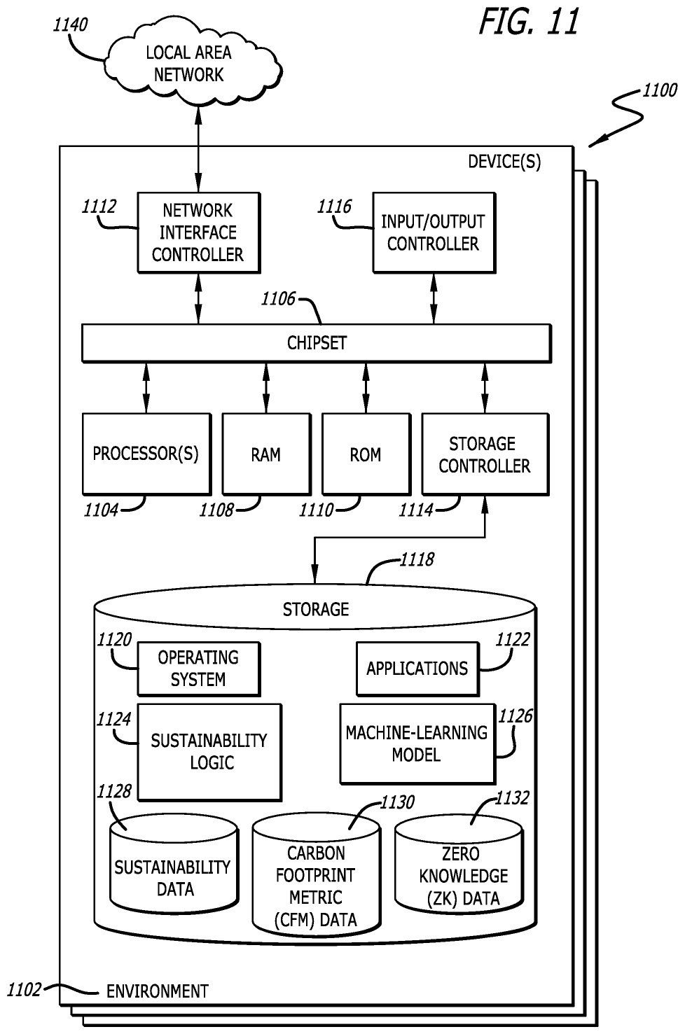

Referring to FIG. 11, a conceptual block diagram of a device 1100 suitable for configuration with a calibration logic, in accordance with various embodiments of the disclosure is shown. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, applications 1122, sustainability data 1128, CFM data 1130, and ZK data 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 918 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many further embodiments, the device 1100 may include a sustainability logic 1124. The sustainability logic 1124 can be configured to perform one or more of the various steps, processes, operations, and/or other methods that are described above. Often, the sustainability logic 1124 can be a set of instructions stored within a non-volatile memory that, when executed by the processor(s)/controller(s) 1104 can carry out these steps, etc. In some embodiments, the sustainability logic 1124 may be a client application that resides on a network-connected device, such as, but not limited to, a server, switch, personal or mobile computing device in a single or distributed arrangement. In certain embodiments, the sustainability logic 1124 can receive and normalize the CFMs of the device 1100, generate the ZK attestation and the verifiable ZK proof for the normalized CFMs, and can transmit the verifiable ZK proof to the auditor. In more embodiments, the sustainability logic 1124 can also monitor and control the energy consumption of the device 1100 to comply to the carbon footprint threshold. In some more embodiments, the ZK data 1132 may store the ZK attestation or the verifiable ZK proof. The CFM data 1130 can store one or more of: the CFMs, the normalized CFMs, the attested CFMs, or the aggregated CFM.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126.

The ML model(s) 1126 can be configured to generate inferences to make predictions or draw conclusions from data. An inference can be considered the output of a process of applying a model to new data. This can occur by learning from at least the sustainability data 1128, the CFM data 1130, and the ZK data 1132 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes.

Although a specific embodiment for a device suitable for configuration with a calibration logic for carrying out the various steps, processes, methods, and operations described herein is discussed with respect to FIG. 11, any of a variety of systems and/or processes may be utilized in accordance with embodiments of the disclosure. For example, the device may be in a virtual environment such as a cloud-based network administration suite, or it may be distributed across a variety of network devices or APs. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a sustainability logic, configured to:
receive one or more normalized Carbon Footprint Metrics (CFMs) corresponding to a timeframe;
generate a Zero Knowledge (ZK) attestation if a sum of the one or more normalized CFMs is less than a carbon footprint threshold;
generate a verifiable ZK proof based on the ZK attestation; and
transmit the verifiable ZK proof to an auditing device.

2. The device of claim 1, wherein the verifiable ZK proof includes the ZK attestation, a device identifier corresponding to the device, and a time data.

3. The device of claim 2, wherein the time data includes at least one of: the timeframe, or a timestamp indicative of a time of generation of the verifiable ZK proof.

4. The device of claim 3, wherein the sustainability logic is further configured to:
determine a key value and an offset value based on the one or more normalized CFMs and the carbon footprint threshold such that the sum of the one or more normalized CFMs and the offset value is greater than the carbon footprint threshold; and
apply a hash on the key value based on at least one of: the carbon footprint threshold, the offset value, or the sum of the one or more normalized CFMs to generate the ZK attestation.

5. The device of claim 4, wherein the verifiable ZK proof is verified by the auditing device by applying the hash on the verifiable ZK proof based on the carbon footprint threshold.

6. The device of claim 5, wherein the sustainability logic is further configured to:
compare the sum of the one or more normalized CFMs with the carbon footprint threshold dynamically;
generate the verifiable ZK proof if the sum of the one or more normalized CFMs is less than the carbon footprint threshold; and
adjust an energy consumption of the device dynamically if the sum of the one or more normalized CFMs is not less than the carbon footprint threshold.

7. The device of claim 1, wherein the one or more normalized CFMs correspond to at least one of: a single greenhouse gas metric, multiple greenhouse gas metrics, or a composite sustainability metric.

8. The device of claim 1, wherein the sustainability logic is further configured to:
collect a real-time telemetry data indicative of a diverse sustainability data; and
generate the one or more normalized CFMs based on the real-time telemetry data.

9. The device of claim 5, wherein the sustainability logic is further configured to:
determine an actual energy usage of the device based on the one or more normalized CFMs; and
control an energy consumption of the device dynamically such that the actual energy usage of the device is less than a maximum energy usage indicated by the carbon footprint threshold.

10. A method, comprising:
receiving one or more normalized Carbon Footprint Metrics (CFMs) corresponding to a timeframe;
generating a Zero Knowledge (ZK) attestation if a sum of the one or more normalized CFMs is less than a carbon footprint threshold;
generating a verifiable ZK proof based on the ZK attestation; and
transmitting the verifiable ZK proof to an auditing device.

11. The method of claim 10, further comprising:
determining a key value and an offset value based on the one or more normalized CFMs and the carbon footprint threshold such that the sum of the one or more normalized CFMs and the offset value is greater than the carbon footprint threshold; and
applying a hash on the key value based on at least one of: the carbon footprint threshold, the offset value, or the sum of the one or more normalized CFMs for generating the ZK attestation.

12. The method of claim 11, further comprising:
comparing the sum of the one or more normalized CFMs with the carbon footprint threshold dynamically;
generating the verifiable ZK proof if the sum of the one or more normalized CFMs is less than the carbon footprint threshold; and
adjusting an energy consumption of a device dynamically if the sum of the one or more normalized CFMs is not less than the carbon footprint threshold.

13. The method of claim 12, further comprising verifying the verifiable ZK proof by applying the hash on the verifiable ZK proof based on the carbon footprint threshold.

14. The method of claim 10, further comprising:
collecting a real-time telemetry data indicative of a diverse sustainability data; and
generating the one or more normalized CFMs based on the real-time telemetry data.

15. A device, comprising:
a processor;
a memory communicatively coupled to the processor; and
a sustainability logic, configured to:
receive one or more normalized Carbon Footprint Metrics (CFMs) corresponding to a timeframe;
compare a sum of the one or more normalized CFMs with a carbon footprint threshold dynamically;
adjust an energy consumption of the device dynamically if the sum of the one or more normalized CFMs is not less than the carbon footprint threshold; and
generate a Zero Knowledge (ZK) attestation if the sum of the one or more normalized CFMs is less than the carbon footprint threshold.

16. The device of claim 15, wherein the sustainability logic is further configured to:
generate a verifiable ZK proof that includes the ZK attestation, a device identifier corresponding to the device, and a time data; and
transmit the verifiable ZK proof based on the ZK attestation to an auditing device.

17. The device of claim 16, wherein the time data includes at least one of: the timeframe, or a timestamp indicative of a time of generation of the verifiable ZK proof.

18. The device of claim 17, wherein the sustainability logic is further configured to:
determine a key value and an offset value based on the one or more normalized CFMs and the carbon footprint threshold such that the sum of the one or more normalized CFMs and the offset value is greater than the carbon footprint threshold; and
apply a hash on the key value based on at least one of: the carbon footprint threshold, the offset value, or the sum of the one or more normalized CFMs to generate the ZK attestation.

19. The device of claim 18, wherein the verifiable ZK proof is verified by applying the hash on the verifiable ZK proof based on the carbon footprint threshold.

20. The device of claim 15, wherein the sustainability logic is further configured to:
collect a real-time telemetry data indicative of a diverse sustainability data; and
generate the one or more normalized CFMs based on the real-time telemetry data.
